(19) United States
(12) Patent Application Publication
(10) Pub. No.: US 2006/0105186 A1
(43) Pub. Date: May 18, 2006

(54) Heat sealable lidding material with anti fog

(76) Inventor: Terrance D. Kendig, Newark, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/274,731

(22) Filed: Nov. 15, 2005

Related U.S. Application Data
(60) Provisional application No. 60/628,454, filed on Nov. 16, 2004.

(51) Int. Cl. B32B 27/34

(52) U.S. Cl. 428/474.4; 428/500

(57) ABSTRACT

A film coated with a surfactant or residue of a surfactant is disclosed. The film comprises, or is produced from, an ethylene copolymer or modified ethylene copolymer or ionomer thereof and a tackifier. The ethylene copolymer is a copolymer or terpolymer or tetrapolymer comprising repeat units derived from ethylene and about 5 to about 50 wt % of a polar monomer. The tackifier can comprise para-coumarone-indene resins, terpene resins, butadiene-styrene resins, polybutadiene resins, hydrocarbon resins, rosins, or combinations of two or more thereof. The monomer can be vinyl alkanoic acid, acrylic acid, alkyl acrylic acid, or alkyl acrylate, or combinations of two or more thereof.

This application claims priority to U.S. provisional application 60/628454, filed Nov. 16, 2004, the entire disclosure of which is incorporated herein by reference.

The invention relates to a film having coated or incorporated thereon or therewith a surfactant and to a process for applying a surfactant onto a film.

### BACKGROUND OF THE INVENTION

Applications packaging fresh refrigerated products such as meat or poultry require a clear view of the product inside the package. In many cases a packaging film is heat-sealed to the lid or flange of a tray material to protect the product. In such cases there is an area of headspace between the product in the tray and the lidding film. This headspace is generally filled with a modified atmosphere to extend product shelf life. It is essential that the packaged product remain in clear view to the consumer at retail. In order to achieve this aesthetic, an antifog agent is desirable to eliminate the undesirable visual effect caused by wet products that generate high humidity inside the package.

Surfaces of polyethylene (PE) film coated with an antifog agent may produce a desired effect, but PE film is not as good packaging material as ethylene copolymers such as ethylene vinyl acetate (EVA) copolymers and ethylene methacrylate (EMA) copolymers. Such ethylene copolymers have very different chemical and physical properties from PE. It is not known whether an ethylene copolymer film may be coated with an antifog agent to be made anti-fogging. Inventor's own tests showed that it is difficult to coat an antifog onto EVA and EMA copolymers and that a large amount of antifog agent is required to achieve antifogging effect. One of the problems may be due to the repeat units derived from polarity monomers such as acetate or acrylate or to the polarity of sealant employed. Wishing not to be bound by theory, it is believed films containing a polar sealant such as tackifier increase antifog inefficiencies due to increased polarity. Furthermore, an antifog becomes a contaminant once it is applied onto an ethylene copolymer film and the coated film is difficult to simultaneously remain both antifogging and heat-seal.

A need therefore exists in the packaging industry for different ethylene copolymer film or laminate with antifogging properties. It is also desirable to develop an antifogging film, when exposed and pulled at a given temperature such as 32° F. (0° C.), increases in heat seal strength. Such film may facilitate transporting and moving product through distribution. Additionally such antifog film can be used as the lidstock to seal to a tray material and provide the antifog surface interface between the headspace and the product packaged.

### SUMMARY OF THE INVENTION

The invention comprises a film coated with a surfactant or residue of a surfactant in which the film comprises or is produced from an ethylene copolymer or modified ethylene copolymer or an ionomer thereof.

The invention also comprises a process for producing a film comprising dissolving a surfactant in a solvent to produce a surfactant solution; applying the surfactant solution onto a film to produce a coating on the film; and optionally curing the coating.

### DETAILED DESCRIPTION OF THE INVENTION

The term “film” used here may be exchangeable with “laminate” or “sheet” and can comprise or be produced from an ethylene copolymer or modified ethylene copolymer or an ionomer thereof. An ethylene copolymer can be a copolymer or terpolymer or tetrapolymer comprising repeat units derived from ethylene and about 5 to about 50%, or about 9 to about 25%, or about 10 to about 19%, or 12 to 15%, by weight (wt %) of a polar monomer, based on the total weight of the ethylene copolymer. The monomer can be vinyl alkanoic acid, acrylic acid, alkyl acrylic acid, or alkyl acrylate, or combinations of two or more thereof in which each monomer may contain up to about 20 carbon atoms and the alkyl group can be methyl, ethyl, butyl, isobutyl, pentyl, hexyl, or combinations of two or more thereof.

Examples of such polar monomers include vinyl acetic acid, acrylic acid, methacrylic acid, ethacrylic acid, vinyl acetate, methyl acrylate, ethyl acrylate, methyl methacrylate, ethyl methacrylate, propyl acrylate, propyl methacrylate, isopropyl acrylate, isopropyl methacrylate, butyl acrylate, butyl methacrylate, isobutyl acrylate, isobutyl methacrylate, tert-butyl acrylate, tert-butyl methacrylate, octyl acrylate, octyl methacrylate, undecyl acrylate, undecyl methacrylate, octadecyl acrylate, octadecyl methacrylate, dodecyl acrylate, dodecyl methacrylate, 2-ethylhexyl acrylate, 2-ethylhexyl methacrylate, isobornyl acrylate, isobornyl methacrylate, lauryl acrylate, lauryl methacrylate, 2-hydroxyethyl acrylate, 2-hydroxyethyl methacrylate, glycidyl acrylate, glycidyl methacrylate, poly(ethylene glycol)acrylate, poly(ethylene glycol)methacrylate, poly(ethylene glycol)methyl ether acrylate, poly(ethylene glycol)methyl ether methacrylate, poly(ethylene glycol)behenyl ether acrylate, poly(ethylene glycol)behenyl ether methacrylate, poly(ethylene glycol) 4-nonylphenyl ether acrylate, poly(ethylene glycol) 4-nonylphenyl ether methacrylate, poly(ethylene glycol)phenyl ether acrylate, poly(ethylene glycol)phenyl ether methacrylate, dimethyl maleate, diethyl maleate, dibutyl maleate, dimethyl fumarate, diethyl fumarate, dibutyl fumarate, dimethyl fumarate, vinyl acetate, vinyl propionate, and combinations of two or more thereof.

An ethylene copolymer may comprise up to 35 wt % of an optional comonomer such as carbon monoxide, sulfur dioxide, acrylonitrile; maleic anhydride, maleic acid diesters, (meth)acrylic acid, maleic acid, maleic acid monoesters, itaconic acid, fumaric acid, fumaric acid monoester, a salt of these acids, glycidyl acrylate, glycidyl methacrylate, and glycidyl vinyl ether, and combinations of two or more thereof.

The acid moiety of an ethylene copolymer may be neutralized with a cation to produce an ionomer. An ethylene copolymer in which the repeat units derived from an acid that is not neutralized is also referred to as ethylene acid copolymer or acid polymer. The neutralization, for example, can range from about 0.1 to about 100, or about 10 to about 90, or about 20 to about 80, or about 20 to about 40 percent, based on the total carboxylic acid content, with a metallic ion. The metallic ions can be monovalent, divalent, trivalent, multivalent, or combinations of two or more thereof. Examples include Li, Na, K, Ag, Hg, Cu, Be, Mg, Ca, Sr, Ba, Cd, Sn, Pb, Fe, Co, Zn, Ni, Al, Sc, Hf, Ti, Zr, Ce, and combinations of two or more thereof. If the metallic ion is multivalent, a complexing agent, such as stearate, oleate, salicylate, and phenolate radicals can be included, as disclosed in U.S. Pat. No. 3,404,134.

The ionomer can also be a blend of an ionomer having a greater than 20% neutralization and, for example, an ethylene(meth)acrylic acid copolymer to achieve the desired degree of neutralization.

For example, an ethylene alkyl acrylate copolymer can comprise from 1 to 30 weight % of at least one E/X/Y copolymer wherein E comprises ethylene; X is a monomer selected from the group consisting of vinyl acetate and alkyl(meth)acrylic esters; and Y is one or more optional comonomers disclosed above; X is from 0 to 50 weight % of the E/X/Y copolymer, Y is from 0 to 35 weight % of the E/X/Y copolymer, wherein the weight % of X and Y cannot both be 0, and E being the remainder.

Examples of ethylene copolymers include, but are not limited to, ethylene/vinyl acetate (EVA), ethylene/methyl acrylate (EMA), ethylene/ethyl acrylate (EEA), ethyl acrylate (EA), ethylene/butyl acrylate (EBA), ethylene/isobutyl acrylate/methacrylic acid, ethylene/methyl acrylate/maleic anhydride, ethylene/butyl acrylate/glycidyl methacrylate (EBAGMA) and ethylene/butyl acrylate/carbon monoxide (EBACO), and butylacrylate (BA).

Examples of commercially available ethylene copolymers include those available from E. I. du Pont de Nemours and Company (DuPont), Wilmington, Del., carrying the trademarks of Surlyn®, Nucrel®, Appeel®, Bynel®, Elvaloy®, and Elvax®

Such ethylene copolymers can be produced by any means known to one skilled in the art using either autoclave or tubular reactors (e.g., U.S. Pat. No. 3,404,134, U.S. Pat. No. 5,028,674, U.S. Pat. No. 6,500,888 and U.S. Pat. No. 6,518,365).

For example, an ethylene copolymer can be produced at high pressure and elevated temperature in a tubular reactor. The inherent consequences of dissimilar reaction kinetics for the respective ethylene and alkyl(meth)acrylate (e.g. methyl acrylate) comonomers is alleviated or partially compensated by the intentional introduction of the monomers along the reaction flow path within the tubular reactor. Such tubular reactor-produced ethylene copolymer has a greater relative degree of heterogeneity along the polymer backbone (a more blocky distribution of comonomers), reduced long chain branching, and a higher melting point than one produced at the same comonomer ratio in a high pressure stirred autoclave reactor. For additional information for tubular reactor-produced and autoclave produced ethylene copolymers, see Richard T. Chou, Mimi Y. Keating and Lester J. Hughes, “High Flexibility EMA made from High Pressure Tubular Process”, Annual Technical Conference—Society of Plastics Engineers (2002), 60th(Vol. 2), 1832-1836. Tubular reactor produced ethylene copolymers are commercially available from DuPont. Certain such ethylene copolymers available from DuPont have a melt flow (g/10 minute) from about 0.1 to about 10 and comprise repeat units derived from an alkyl acrylate from about 5 to about 30 wt %.

An ethylene copolymer can also include fillers or additives such as slip additive (e.g., n-oleyl palmitamide, stearamide, and benhenamide), anti block agent such as silica (diatomaceous earth or silica dioxide particles), CaCO₃, UV stabilizer, pigment, or combinations of two or more thereof.

An ethylene copolymer can comprise, or be modified by including, from about 0.001 to about 35, or about 0.1 to about 30, weight % of at least one tackifier, which can enhance adhesion to differentiated substrates.

Any tackifier, also referred to as adhesive, known to one skilled in the art such as those disclosed in U.S. Pat. No. 3,484,405 can be used. Such tackifiers include a variety of natural and synthetic resins and rosin materials. The resins can be liquid, semi-solid to solid, or solid, including complex amorphous materials generally in the form of mixtures of organic compounds having no definite melting point and no tendency to crystallize. Such resins may be insoluble in water and can be of vegetable or animal origin, or can be synthetic resins. The resins can provide substantial and improved tackiness to the composition. Suitable tackifiers include, but are not limited to, para-coumarone-indene resins, terpene resins, butadiene-styrene resins, polybutadiene resins, hydrocarbon resins, rosins, and combinations of two or more thereof.

Generally the coumarone-indene resins have a molecular weight ranging from about 500 to about 5,000. Examples of resins of this type that are available commercially include those materials marketed as “Picco”-25 and “Picco”-100.

The terpene resins include styrenated terpenes and can have a molecular weight ranging from about 600 to 6,000. Examples of commercially available resins are marketed as “Piccolyte” S-100, as “Staybelite Ester” #10 (Eastman Chemical, Kingsport, Tenn.), which is a glycerol ester of hydrogenated rosin, and as “Wingtack” 95, which is a polyterpene resin. A terpene resin-based tackifier of note is derived from poly-limonene, a monomer recovered from the citrus industry, available as Piccolyte® C115 from Pinova.

The butadiene-styrene resins can have a molecular weight ranging from about 500 to about 5,000. Example of commercial product is marketed as “Buton” 100, a liquid butadiene-styrene copolymer resin having a molecular weight of about 2,500.

The polybutadiene resins can have a molecular weight ranging from about 500 to about 5,000. A commercially available example is that marketed as “Buton” 150, a liquid polybutadiene resin having a molecular weight of about 2,000 to about 2,500.

A hydrocarbon resin can be produced by catalytic polymerization of selected fractions obtained in the refining of petroleum, and can have a molecular weight ranging from about 500 to about 5,000. Examples of such resin are those marketed as “Piccopale”-100, and as “Amoco” and “Velsicol” resins. Similarly, polybutenes obtained from the polymerization of isobutylene may be included as a tackifier.

The tackifier may also include rosin materials, low molecular weight (such as, for example, 1300) styrene hard resins such as the material marketed as “Piccolastic” A-75, disproportionated pentaerythritol esters, and copolymers of aromatic and aliphatic monomer systems of the type marketed as “Velsicol” WX-1232. The rosin that may be employed in the present invention may be gum, wood or tall oil rosin but preferably is tall oil rosin. Also the rosin material may be modified rosin such as dimerized rosin, hydrogenated rosin, disproportionated rosin, or esters of rosin. Esters can be prepared by esterifying the rosin with polyhydric alcohols containing from 2 to 6 alcohol groups.

Another tackifier resin of note is Regalite R1125 (a hydro carbon) available from Eastman Chemical.

A more comprehensive listing of tackifiers, can be found in the TAPPI CA Report #55, February 1975, pages 13-20, a publication of the Technical Association of the Pulp and Paper Industry, Atlanta, Ga., which lists well over 200 tackifier resins that are commercially available.

The tackifier may be either combined directly with the ethylene copolymer or other components disclosed; or pre-melt compounded into a masterbatch formulation. Such technology is described in U.S. Pat. No. 6,255,395 and JP 2002 173,653, entire disclosures of both are incorporated herein. For example, poly-limonene may be blended with an ethylene/octane copolymer to prepare a tackifier masterbatch that can be added to the remaining components of the composition in a subsequent blending operation.

Some of the ethylene copolymers can be further modified by mixing or blending, for example, about 50 to about 90 wt % EVA and about 10 to about 50 wt % of an ionomer disclosed above. Modified ethylene copolymer can also comprise or be produced from mixing or blending about 50 to about 90 wt % EVA, about 5 to about 40 wt % of an ionomer, and about 5 to about 10 wt % of EVA masterbatch containing an additive such as slip and anti block concentrate. Specific examples of modified ethylene copolymer can include blend of (1) EVA (75%), ionomer (18%), and EVA masterbatch (slip additive and anti block agent; 7%) and (2) EVA (87%), acid copolymer (9%), and EVA masterbatch (slip additive and anti block agent; 4%). EVA can contain about 4 to about 35 wt % repeat units derived from vinyl acetate. The copolymers containing slip and anti block, wishing not to be bound by theory, can improve extrusion processing and ease of handling the finished film product, but these additives can contribute to the difficulty for having a functional antifog as they affect surface area making wetting out of the coating more difficult.

Film may be produced from a molten composition disclosed herein by a number of methods known in the art (for example, cast film extrusion or blown film extrusion). Films can be oriented in one direction by hot-drawing in the machine direction with a tensioning device, and annealing. Films can also be oriented in two directions (machine direction and transverse direction) by suitable tensioning devices. Because processes for producing films are well known to one skilled in the art, the description of which is omitted herein for the interest of brevity.

Multilayer film can also be produced by any methods known to one skilled in the art. For example, a multilayer film can be produced by charging each of the polymers for the different layers of the film into separate extruders and melting the component and pumping the melted component through a pipe into a feed block that layers the different flows together just prior to entering an extrusion die manifold as a single flow stream. A molten curtain of multiple layers exits the extrusion die and is deposited onto a moving roll which transfers the cooling multi-layer sheet material into a counter rotating moving roll through a gap or nip and then typically to a third cooling roller and subsequently through a take-off system to another nip between two rollers which pulls the sheet to a take-off system.

The term “antifog agent” or “antifogging agent” refers to a chemical or substance effectively keeping water from condensing on the surface of a plastic film producing undesirable water droplets or fogging or retarding the formation of fog. The term “antifogging amount” is the amount that, when coated onto a film, can substantially reduce or remove fogging from the film that is exposed to water or vapor. Wishing not to be bound by theory, it is believed that the agent can reduce the surface tension of water thereby reducing the removing fog produced from water.

Antifogging agent can be a surfactant or a residue of the surfactant that is approved for food use such as alkanoic acids or their ammonium or metal salts, alkanols, alkoxylated compounds, quaternary ammonium salts, alkali metal alkyl sulfates, alkali metal salts of alkaryl sulfonic acids, 1-alkyl pyridinium salts, or combinations of two or more thereof.

Of note is an alkanol or alkanoic acid (or its metal salts or its esters) such as, for example, sorbitan, fatty esters, glycerol mono stearate, glycerol mono oleate, fatty alcohols, and combinations of two or more thereof. The weight ratio of antifogging agent to the ethylene copolymer can range from about 0.0001:1 to about 1:1, or about 0.001:1 to about 0.5:1, or about 0.001:1 to 0.1:1.

Preferably an antifog agent does not include a material, which may interfere with the antifog property. For example, such material can be a layer containing a polymer with the antifog agent contained thereon such as a blend of polyolefin and an antifog agent disclosed in U.S. Pat. No. 5,567,533.

An antifog agent can be dissolved in any solvent, preferably one that has a high evaporation rate or volatility under the temperature and pressure of application. For example, it can have an evaporation rate of >0.01 relative to n-butyl acetate which has an assigned value of 1. A solvent preferably can be dried at less than 80° C.

Solvent can include alcohols, ketones, esters, ethers, acids, hydrocarbons or derivatives thereof, and combinations of two or more thereof. Examples of solvents include methanol, ethanol, propanol, isopropanol, acetone, ethyl acetate, butyl acetate, methyl ethyl ketone, tetrahydrofuran, dioxane, octane, decane, cyclohexane, toluene, xylene, methylene chloride, methylene dichloride, ethylene dichloride, carbon tetrachloride, chloroform, perchloroethylene, white spirit, mineral spirits, naphtha, and combinations of two or more thereof. Dilution with a solvent can range from are 0.2% to 10%, or 1 to 2%, of antifog agent by volume.

An antifog agent, preferably in a solvent, can be coated or applied onto an ethylene copolymer film disclosed above by any means known to one skilled in the art such as, for example, spraying, dipping, brushing, vapor depositing, printing, spin coating, transferring, flow coating, and combinations of two or more thereof.

The antifog film disclosed above can also be melt extruded, coextruded, multi-layer coextruded with, include additional film layers of, other polymers. Examples of other polymers include nylon, polypropylene, polyethylene, polyethylene terephthalate, polystyrene, polyethylene vinyl alcohol (EVOH), polyvinylidene chloride, and combinations of two or more thereof.

For example, an additional film can have heat shrinkage of 5% or 10% more than the heat shrinkage film of the composition disclosed above.

Also for example, a multilayer heat shrinkable film or laminate that can be used for packaging can comprise or produced from a film produced from another polymer. The additional film may be heat shrinkable such as that comprises about 80 wt % or more of polyester such polyethylene terephthalate, with the film is biaxially oriented in the range of about 5% to about 55%, or about 5 to 30%, or about 5 to 10% shrink factor. This film can be laminated with the film comprising or produced from the composition disclosed above.

The lidding can have a thickness in the range of 12-75, or 12-20, micrometers (μ) for lidding applications such as lidding disposable containers. A container is a shaped article for use in packaging or containing foods, medicines, agrochemicals, industrial liquids and the like, and include, for example, boxes, blister packs, bottles, trays, cups, and other like-bottomed containers.

The antifog agent can also be combined with an adhesive to produce a sealant or adhesive layer comprising antifog agent. Such layer can be used to produce film or laminate disclosed herein for the antifog application. Any adhesive can be employed such as solvent-less laminating adhesives such as waterborne acrylic emulsions, polyurethane dispersions, elastomer (e.g., polyurethanes), and one and two part 100% solids polyurethane systems are well known to one skilled in the art.

Solvent type adhesives can also be used such as polyether urethane (e.g., Lamal HSA/Catalyst CR-1-80 available from Rohm & Haas, Philadelphia, Pa.). A Lamal HSA adhesive with coreactant laminating adhesive can be applied by any of the well known coating techniques, preferably a gravure station coating typically used in solution coating processes.

Film disclosed above can further include an additional layer that is not permeable to oxygen, moisture, or both. Such barrier may be useful in many food packaging applications. Such additional layer can be on either side of the film or intermediate another layer and the film-containing antifog agent. The additional layer can be made from, for example, EVOH or a vinylidene polymer such as polyvinylidine chloride copolymer (PVDC).

The film-containing antifog can also be adhesive-laminated to a film or layer made from, or coextruded with, nylon, polypropylene, polyethylene, linear low density polyethylene, ionomer, ethylene acid copolymer, ethylene vinyl acetate, ethylene methyl acrylate, polyethylene terephthalate, polystyrene, EVOH, or PVDC.

The film or laminate can be made with, for example, a gravure or anilox cylinder. For example, a quadrangular cell can be used. Other types of engraved cylinders available are Pyramid and Trihelicals Gravure cylinder cell size and dilution ratios can be adjusted to apply a desired amount of antifog coating depending on the type of cylinder used. The antifog can be applied as a pattern or registered on the film similar to printing methods. It may be desirable that the antifog agent is in areas on the film where it is useful and out of the area where the film is sealed. Preferred conditions include direct gravure with application cell size (110-200 lines).

The invention also includes a package that can comprise or be produced from a container and film or multilayer film as disclosed above. A container can have an open end, which can be covered with a film or laminate disclosed above and can be in any shapes or forms such as square, rectangular, triangular, round, trapezoid, and other shapes or forms known to one skilled in the art. The container can include a product such as produce or fresh produce, meats, readily to eat meals, prepared foods, sea foods, or combinations of two or more thereof. The container can be made from any materials known to one skilled in the art such as foam fiber, metal, plastics, papers, or combinations of two or more thereof.

### EXAMPLES

The following examples are provided to illustrate, not to unduly limit the scope of, the invention. In the examples the dilution percentage is by volume.

An anti-fogging agent was added to one surface of a lamination by topical coating using a gravure cylinder metering method. Differential laminating substrates can be fabricated using either solvent or solvent-less type adhesive systems. Antifog agents tested were supplied by Ciba Specialty Chemical under the trade name of Atmer, in liquid form and could be diluted in ethanol, methanol or isopropanol to the desired concentration level. Type tested were Atmer 1440 and Atmer 100. Atmer 1440 is preferred due to overall anti fog performance and being most environmentally friendly.

Effective dilution ratios ranged from 0.2% to 10% with 3%-7% preferred based on the gravure cylinder selected for the example below. Dilution ratios varied with different gravure cylinders or with different engraved cell sizes. Gravure cylinder cell size and dilution ratios could affect the amount of antifog coating applied to a film (sealant layer). Typical laminating and antifog application steps included applying adhesive by gravure to 1^{st} base film (e.g., polyester, nylon or polypropylene) at a coating station as a carrier for the adhesive; continuing through a hot air dryer (1^{st} dryer system); combining with a 2^{nd} sealant film applying pressure via hot nip roll; fully laminating roll passes through 2^{nd} gravure station that applies diluted anti fog agent directly onto sealant side of 2nd film; rolling passes through 2^{nd} dryer system; and onto winding station for finishing rolling.

If a second gravure and drying station were not available on existing equipment, the roll was wound up first after laminating; the adhesive was replaced at the coating station with diluted antifog agent; and the roll then unwound as it passed through the gravure station and coating said film with antifog agent and passed through the dryer station a second time winding up into the finished roll.

### Example 1

### Anti Fog Coating

In this example a two-pass process was used. A first substrate of 48 gauge polyester (PET) film known under the trade name Mylar® supplied by DuPont Teijin Films was adhesive-laminated to a second substrate of 2.5 mil (63.5 μ) blown film coextruded structure. Two blown film structures for lamination were produced as follows: (1) 1.0 mil (25.4 μ) HDPE/0.5 mil (12.7 μ) HDPE+LDPE blend/0.5 mil (12.7 μ) Modified EVA and (2) 1.0 mil (25.4 μ) HDPE/0.5 mil (12.7 μ) HDPE+LDPE blend/0.5 mil (12.7 μ) Modified EMA. The lamination was made by (1) applying a solvent type adhesive (Adcote 503A/Catalyst F available from Rohm & Haas, Philadelphia, Pa.) to the corona-treated and coated side of Mylar® by an engraved 110 quadrangular gravure cylinder at a coating station and (2) running and drying the adhesive coated web through a hot air oven at 160° F. (71.1° C.) and (3) under pressure hot nipping the Mylar® to the secondary coextruded films on the corona treated HDPE side at 160° F. (71.1° C.) and winding up the roll thus completing the lamination. The adhesive and solvent for dilution are selected for good adhesion between the Mylar® and blown film HDPE side of the coextruded films. Adcote 503A adhesive was a polyether urethane component of a two-component laminating adhesive, which required the use of a coreactant. This polyether urethane, in conjunction with coreactant F, functions as an adhesive for bonding differentiated film materials.

The adhesive in the coating station was replaced with a diluted solution of Atmer 1440. Diluting of 3, 5 and 7% of the Atmer 1440 anti fogging agent in isopropanol to make the solution. The laminate was unwound and taken though the coating station using selected 110 and 200 quad engraved gravure cylinder to apply the anti fog solution to the modified EVA and EMA heat sealable sides of the film.

After the anti fog solution was applied, the web was passed though a hot air dryer at 160° F. (71.1° C.) in order to remove the solvent and dry the surface. The roll was then wound up into the finished product. The same process was used applying 2%, 3% and 5% anti fog solutions to the same laminated film structure. In all cases the film remained clear and had excellent sealability.

### Example 2

The example was carried with Intra Roto Laminator/Coater, 200 Quadrangular coating cylinder by coating antifog solution onto the sealant surface of each modified EVA and EMA film at a speed of 50 ft/min (15,24 m/min) to make an antifog-coated film. The antifog-coated film was dried at 106° F. (71° C.) by removing any residual solvent and curing the coating on the surface of the film. Antifog agent was Atmer 1440 topical solution (3or 5 wt %) in isopropanol. Wet paper towel was placed in the bottom of a tray, which was sealed hermetically with the antifog film leaving headspace between the wet towel and plastic lidding film. The lidded tray was exposed at 35° F. (1.67° C.). At time intervals shown in the table, the appearance of the film was observed and recorded. Appearance was rated as 1 (fogging/condensate), 2 (clear condensate-many droplets), 3 (clear/condensate-few droplets), 4 (clear/condensate-minimal droplets), 5 (clear/condensate-total wetout 1 drop), and 6 (no visible change/no condensate).

| Topcoat | | | | | | |
|---|---|---|---|---|---|---|
| (%) | 2 Hours | 4 Hours | 6 Hours | 24 Hours | 48 Hours | 15 Days |
| 3 | 5 | 6 | 6 | 6 | 6 | 3 |
| 5 | 5 | 6 | 6 | 6 | 6 | 3 |
| 3 | 5 | 6 | 6 | 6 | 6 | 3 |
| 5 | 5 | 6 | 6 | 6 | 6 | 3 |
| 3 | 4 | 4 | 4 | 4 | 4 | 3 |
| 5 | 4 | 4 | 4 | 4 | 3 | 3 |
| 3 | 1 | 1 | 1 | 1 | 1 | 1 |
| 5 | 1 | 1 | 1 | 1 | 1 | 1 |
| 3 | 1 | 1 | 1 | 1 | 1 | 4 |
| 5 | 4 | 4 | 4 | 4 | 4 | 4 |

Not shown in the table is that heat seal exposed at such low temperature actually increased in heat seal strength as measured in grams per inch of width.

### Example 3

The runs shown in Example 2 were repeated with either EVA or EMA as base polymer film coated with antifog. The runs were carried out as disclosed above and the results are shown in the following table where “cell” denotes lines of quadranger gravure cylinder cells. Again, not shown in the table is that heat seal exposed at such low temperature actually increased in heat seal strength.

| Polymer | Coat (%) | Cell | 2 Hours | 4 Hours | 6 Hours | 24 Hours | 48 Hours | 15 Days |
|---|---|---|---|---|---|---|---|---|
| EVA | 5 | 100 | 6 | 5 | 5 | 5 | 5 | 5 |
| EVA | 7 | 200 | 6 | 6 | 6 | 6 | 5 | 5 |
| EVA | 5 | 100 | 5 | 4 | 4 | 3 | 3 | 3 |
| EVA | 7 | 200 | 5 | 4 | 4 | 3 | 3 | 3 |
| EMA | 5 | 100 | 5 | 5 | 5 | 4 | 4 | 4 |
| EMA | 7 | 200 | 5 | 5 | 5 | 5 | 5 | 5 |
| EMA | 5 | 100 | 1 | 1 | 1 | 1 | 3 | 3 |
| EMA | 7 | 200 | 1 | 1 | 1 | 1 | 3 | 3 |
| EMA | 5 | 100 | 6 | 5 | 5 | 5 | 5 | 5 |
| EMA | 7 | 200 | 6 | 5 | 5 | 5 | 5 | 5 |

1. A film coated with a surfactant or residue of a surfactant wherein the film comprises, or is produced from, an ethylene copolymer and a tackifier or modified ethylene copolymer and a tackifier; the ethylene copolymer is a copolymer or terpolymer or tetrapolymer comprising repeat units derived from ethylene and about 5 to about 50 wt % of a polar monomer; the tackifier comprises para-coumarone-indene resins, terpene resins, butadiene-styrene resins, polybutadiene resins, hydrocarbon resins, rosins, or combinations of two or more thereof; the monomer is vinyl alkanoic acid, acrylic acid, alkyl acrylic acid, or alkyl acrylate, or combinations of two or more thereof; and monomer comprises up to about 20 carbon atoms.

2. A film according to claim 1 wherein the monomers is vinyl acetic acid, vinyl acetate, vinyl propionate, acrylic acid, methacrylic acid, ethacrylic acid, vinyl acetate, methyl acrylate, ethyl acrylate, methyl methacrylate, ethyl methacrylate, propyl acrylate, propyl methacrylate, isopropyl acrylate, isopropyl methacrylate, butyl acrylate, butyl methacrylate, isobutyl acrylate, isobutyl methacrylate, tert-butyl acrylate, tert-butyl methacrylate, octyl acrylate, octyl methacrylate, undecyl acrylate, undecyl methacrylate, octadecyl acrylate, octadecyl methacrylate, dodecyl acrylate, dodecyl methacrylate, 2-ethylhexyl acrylate, 2-ethylhexyl methacrylate, isobornyl acrylate, isobornyl methacrylate, lauryl acrylate, lauryl methacrylate, 2-hydroxyethyl acrylate, 2-hydroxyethyl methacrylate, glycidyl acrylate, glycidyl methacrylate, poly(ethylene glycol)acrylate, poly(ethylene glycol)methacrylate, poly(ethylene glycol)methyl ether acrylate, poly(ethylene glycol)methyl ether methacrylate, poly(ethylene glycol)behenyl ether acrylate, poly(ethylene glycol)behenyl ether methacrylate, poly(ethylene glycol) 4-nonylphenyl ether acrylate, poly(ethylene glycol) 4-nonylphenyl ether methacrylate, poly(ethylene glycol)phenyl ether acrylate, poly(ethylene glycol)phenyl ether methacrylate, dimethyl maleate, diethyl maleate, dibutyl maleate, dimethyl fumarate, diethyl fumarate, dibutyl fumarate, dimethyl fumarate, or combinations of two or more thereof and is preferably vinyl acetate, acrylic acid, methacrylic acid, or alkyl(meth)acrylate.

3. A film according to claim 2 where in the tackifier comprises a coumarone-indene resin, a terpene resin, a butadiene-styrene resin, a polybutadiene resin, a hydrocarbon resin, a rosin material, or combinations of two or more thereof.

4. A film according to claim 1 further comprising a sealant layer.

5. A film according to claim 3 further comprising a sealant layer.

6. A film according to claim 4 wherein the surfactant or residue of surfactant is present in the sealant layer.

7. A film according to claim 5 wherein the surfactant or residue of surfactant is present in the sealant layer.

8. A film according to claim 2 comprising an additional layer, which comprises or is produced from nylon, polypropylene, polyethylene, ionomer, acid copolymer, polyethylene vinyl acetate, polyethylene terephthalate, polystyrene, polyethylene vinyl alcohol, polyvinylidene chloride, or combinations of two or more thereof.

9. A film according to claim 3 comprising an additional layer, which comprises or is produced from nylon, polypropylene, polyethylene, ionomer, acid copolymer, polyethylene vinyl acetate, polyethylene terephthalate, polystyrene, polyethylene vinyl alcohol, polyvinylidene chloride, or combinations of two or more thereof.

10. A film according to claim 5 comprising an additional layer, which comprises or is produced from nylon, polypropylene, polyethylene, ionomer, acid copolymer, polyethylene vinyl acetate, polyethylene terephthalate, polystyrene, polyethylene vinyl alcohol, polyvinylidene chloride, or combinations of two or more thereof.

11. A film according to claim 7 comprising an additional layer, which comprises or is produced from nylon, polypropylene, polyethylene, ionomer, acid copolymer, polyethylene vinyl acetate, polyethylene terephthalate, polystyrene, polyethylene vinyl alcohol, polyvinylidene chloride, or combinations of two or more thereof.

12. A film according to claim 2 wherein the film comprises, or is produced from, the modified ethylene copolymer, which is a blend of about 50 to about 90 wt % ethylene vinyl acetate copolymer, about 5 to about 40 wt % of an ionomer, and about 5 to about 10 wt % of ethylene vinyl acetate copolymer masterbatch containing slip additive and anti block agent.

13. A film according to claim 5 wherein the film comprises, or is produced from, the modified ethylene copolymer, which is a blend of about 50 to about 90 wt % ethylene vinyl acetate copolymer, about 5 to about 40 wt % of an ionomer, and about 5 to about 10 wt % of ethylene vinyl acetate copolymer masterbatch containing slip additive and anti block agent.

14. A film according to claim 7 wherein the film comprises, or is produced from, the modified ethylene copolymer, which is a blend of about 50 to about 90 wt % ethylene vinyl acetate copolymer, about 5 to about 40 wt % of an ionomer, and about 5 to about 10 wt % of ethylene vinyl acetate copolymer masterbatch containing slip additive and anti block agent.

15. A film according to claim 11 wherein the film comprises, or is produced from, the modified ethylene copolymer, which is a blend of about 50 to about 90 wt % ethylene vinyl acetate copolymer, about 5 to about 40 wt % of an ionomer, and about 5 to about 10 wt % of ethylene vinyl acetate copolymer masterbatch containing slip additive and anti block agent.

16. A container comprising an open end, which is covered with a film, wherein the container optionally comprises produce, meat, prepared food, or fish and the film is as recited in claim 1.

17. The container of claim 16 wherein the film is as recited in claim 3.

18. The container of claim 16 wherein the film is as recited in claim 15.

19. A process comprising dissolving a surfactant in a solvent to produce a surfactant solution; applying the surfactant solution onto a film to produce a coating on the film; and optionally curing the coating wherein the film is as recited in claim 2.

20. The process of claim 18 wherein the film is as recited in claim 15.
